(19) United States
(12) Patent Application Publication
(10) Pub. No.: US 2020/0167708 A1
(43) Pub. Date: May 28, 2020

(54) CUSTOM EXTENSIONS IN INTERGRATION SETUP WORKFLOWS

(71) Applicant: SAP SE, Walldorf (DE)

(72) Inventor: Manikandan Rajasekar, Chennai (IN)

(21) Appl. No.: 16/199,446

(22) Filed: Nov. 26, 2018

(51) Int. Cl. G06Q 10/06; G06F 9/445; G06Q 10/10; G06F 9/451

(52) U.S. Cl. CPC G06Q 10/06316; G06F 9/44526; H04L 67/42; G06Q 10/063114; G06F 9/451; G06Q 10/103

(57) ABSTRACT

Methods, systems, and computer-readable storage media for executing, within a vendor-provided integration service, a workflow, the workflow including one or more integration tasks, and at least one empty custom extension task, notifying, by the vendor-provided integration service, a user of an enterprise that maintains an enterprise-side landscape of the at least one empty custom extension task, receiving, from the user, input defining a workflow fragment, the workflow fragment including one or more tasks, and being assigned a fragment identifier, setting an enable attribute of the at least one empty custom extension task to true, and associating the at least one empty custom extension task with the fragment identifier to provide a non-empty custom extension task within the workflow, and executing the workflow, during which the one or more tasks of the workflow fragment are performed.

### BACKGROUND

Enterprises leverage vendor-provided systems to provide functionality for their day-to-day operations. In some examples, vendors provide cloud-based software systems that enterprises can integrate their operations with. For example, a vendor can provide a cloud-based human resources management platform that is integrated with systems of the enterprise to enable the enterprise to leverage functionality of the human resources management platform. Integration is a time-consuming, and resource-intensive task that can include technical configurations, process configurations, and provisioning procedures between the cloud-based platform, and a landscape of the enterprise. In some instances, enterprises seek to use third-party, and/or custom developed applications, which also need to be part of the integration space. Such applications further complicate integration execution.

### SUMMARY

Implementations of the present disclosure are directed to integrating enterprise systems with vendor-provided systems. More particularly, implementations of the present disclosure are directed to an integration service that enables custom extensions to address third-party, and/or enterprise-developed applications in integration.

In some implementations, actions include executing, within a vendor-provided integration service, a workflow, the workflow including one or more integration tasks, and at least one empty custom extension task, notifying, by the vendor-provided integration service, a user of an enterprise that maintains an enterprise-side landscape of the at least one empty custom extension task, receiving, from the user, input defining a workflow fragment, the workflow fragment including one or more tasks, and being assigned a fragment identifier, setting an enable attribute of the at least one empty custom extension task to true, and associating the at least one empty custom extension task with the fragment identifier to provide a non-empty custom extension task within the workflow, and executing the workflow, during which the one or more tasks of the workflow fragment are performed. Other implementations of this aspect include corresponding systems, apparatus, and computer programs, configured to perform the actions of the methods, encoded on computer storage devices.

These and other implementations can each optionally include one or more of the following features: the one or more integration tasks include respective tasks defined within vendor-provided documentation for an integration scenario; a monitoring application monitors execution of the workflow, and notifies the user in response to occurrence of the at least one empty custom extension task; the one or more tasks of the workflow fragment are specific to the enterprise, and are associated with one or more of a custom-application that is to be included in the integration scenario, and a third-party application that is to be included in the integration scenario; the use provides the input through a user interface that enables definition of workflow fragments; the user interface is provided by a custom extension editor application of the integration service; and the workflow includes a plurality of empty custom extension tasks, each empty custom extension task being at a location that is available for extension of the workflow.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example integration service architecture in accordance with implementations of the present disclosure.

FIG. 2 depicts an example custom extension architecture in accordance with implementations of the present disclosure.

FIG. 3A depicts an example portion of a workflow with custom extension task.

FIG. 3B depicts an example portion of a workflow with custom extension tasks.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to integrating enterprise systems with vendor-provided systems. More particularly, implementations of the present disclosure are directed to an integration service that enables custom extensions to address third-party, and/or enterprise-developed applications in integration. Implementations can include actions of executing, within a vendor-provided integration service, a workflow, the workflow including one or more integration tasks, and at least one empty custom extension task, notifying, by the vendor-provided integration service, a user of an enterprise that maintains an enterprise-side landscape of the at least one empty custom extension task, receiving, from the user, input defining a workflow fragment, the workflow fragment including one or more tasks, and being assigned a fragment identifier, setting an enable attribute of the at least one empty custom extension task to true, and associating the at least one empty custom extension task with the fragment identifier to provide a non-empty custom extension task within the workflow, and executing the workflow, during which the one or more tasks of the workflow fragment are performed.

To provide further context for implementations of the present disclosure, and as introduced above, enterprises leverage vendor-provided systems to provide functionality for their day-to-day operations. In some examples, vendors provide cloud-based software systems that enterprises can integrate their operations with. For example, a vendor can provide a cloud-based human resources management platform (e.g., SAP SuccessFactors Employee Central provided by SAP SE of Walldorf, Germany) that is integrated with systems of the enterprise to enable the enterprise to leverage functionality of the human resources management platform. Integration is a time-consuming, and resource-intensive task that can include technical configurations, process configurations, and provisioning procedures between the cloud-based platform, and a landscape of the enterprise.

Integration services can be provided to assist in the integration process. An example integration service includes the Cloud Integration Automation Service (CIAS) provided by SAP SE. Implementations of the present disclosure are described in further detail with reference to CIAS provided by SAP SE. It is contemplated, however, that implementations of the present disclosure can be realized with any appropriate integration service.

In general, integration services, such as CIAS, assist enterprises in setting-up the integration between enterprise systems (e.g., an enterprise landscape), and one or more cloud-based platforms provided by a vendor (e.g., vendor-provided systems). With non-limiting reference to SAP SE, an example integration can include integration between a SAP S/4HANA System to SAP SuccessFactors Employee Central to realize an example integration scenario (e.g., new hire). The CIAS simplifies, and optimizes the time required to setup the configuration between landscape components (e.g., systems within landscapes).

In CIAS, the technical configuration, business configuration, and provisioning procedures related to integration setup between landscape components are provided as guided workflows for one or more users. The detailed information about configuration steps and provisioning procedure are stores in a repository within CIAS, which contains the textual description of the procedure. During execution in runtime, this textual information is transformed into workflow tasks. In some examples, an integration scenario may contain numerous configuration tasks, which can span across multiple systems. Setup activities among different systems can include manual tasks that are to be executed by administrators. For example, an integration scenario can include multiple configuration tasks, each configuration task being performed by a particular role (e.g., administrator), and a respective system.

An integration service, such as CIAS, can simplify the integration process with a structured model, and automations using workflow technology. However, others, such as the enterprise, and/or third-parties, follow various custom processes defined within their respective organization boundaries in order to setup an integration between their systems (e.g., an enterprise's custom application, an application provided by a third-party), and the vendor-provided system.

In some examples, the integration service generates a workflow document containing sequence of steps to be executed by different roles to setup an integration between vendor-provided systems with a customer landscape as well as a vendor-managed landscape. As described in further detail herein, the sequence of steps for an integration scenario is dependent on the enterprise documentation, and modelling of steps in a configuration definition repository.

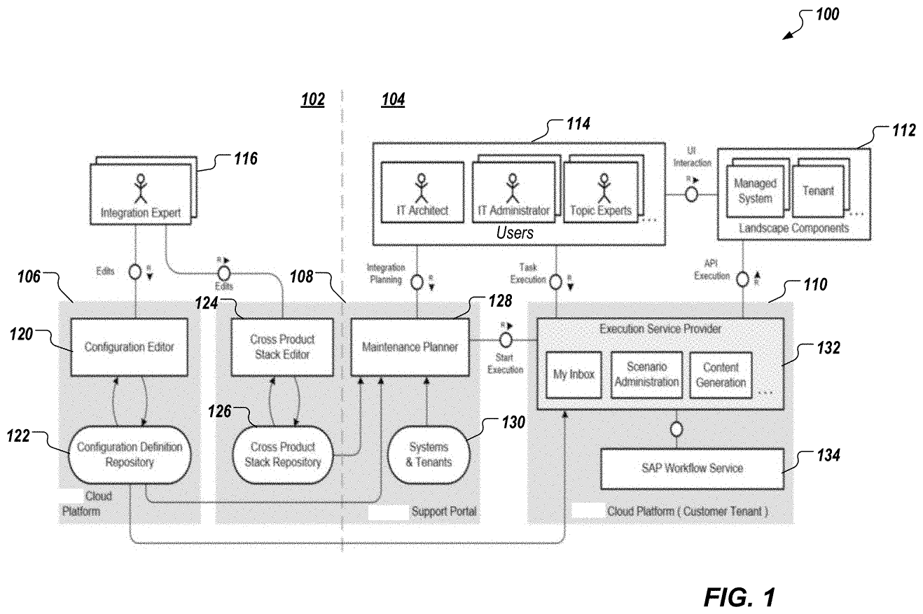

FIG. 1 depicts an example architecture 100 in accordance with implementations of the present disclosure. In the depicted example, the example architecture 100 includes a vendor-side 102, and an enterprise-side 104. In some examples, the vendor-side 102 corresponds to a vendor that provides a vendor-provided system, and the enterprise-side 104 corresponds to an enterprise that consumes the vendor-provided system (e.g., the enterprise is a customer of the user). The example architecture 100 further includes a cloud-platform 106, a support portal 108, and a cloud platform tenant 110. In some examples, the cloud platform 106, the support portal 108, and the cloud platform tenant 110 are provided as part of the vendor-provided system that the enterprise consumes. For example, the cloud platform 106 is a vendor-internal platform that hosts products, and services provided by the vendor, and the cloud platform tenant 110 is a tenant instance, through which the enterprise consumes the products, and services provided by the vendor. In some examples, the support portal 108 enables the enterprise-side 104 to communicate with the vendor-side 102 to perform one or more tasks. In the example of the present disclosure, the enterprise-side 104 engages with the vendor-side 102 through the support portal 108 during an integration scenario.

In further detail, the enterprise-side 104 includes a landscape 112 having one or more components, with which the vendor-provided system is to be integrated. In some examples, one or more users 114 of the enterprise execute at least a portion of the integration. One or more users 116 of the vendor execute at least a portion of the integration.

In the example of FIG. 1, the cloud platform 106 includes a configuration editor 120 that can be used by the one or more users 116 to generate one or more configuration definitions that are stored in a configuration definition repository (CDR) 122. In some examples, the CDR 122 contains vendor-provided configuration definitions as structured documents. In some instances, the documentation only addresses vendor-provided systems, and does not address third-party applications, and/or custom applications that the enterprise also integrates with the landscape 112.

The support portal 108 includes a cross-product stack editor 124, a cross-product stack repository 126, a maintenance planner 128, and a systems and tenants repository 130. The cloud platform tenant 110 includes an execution service provider (ESP) 132, and a workflow service 134. In some implementations, the ESP 132 generates workflows to perform the integration. In some examples, a workflow is generated based on a data model that defines respective tasks, targets, and roles for an integration scenario. For example, for each task (e.g., configuration task) in an integration scenario the data model defines the task, a target, on which the task is to be executed (e.g., a component of the landscape 112), and a role of a user that is to perform the task.

Each customer (enterprise) can have their own customized process to perform the integration setup that is based on the vendor-provided documentation. In some examples, customization can include one or more activities. Example activities can include, without limitation, maintaining a spreadsheet (e.g., a MS Excel workbook), registering tasks in a web page, implementing project management tools, document tasks using screen-shots, using emails for approvals, and performing validation checks. In some examples, and as noted above, the vendor-provided documentation (e.g., configuration definitions) provides the technical steps, or instructions related to the setup of only the vendor-provided systems, and does not address third-party, or custom-developed applications that also integrate with the vendor-provided system, and the enterprise landscape. Consequently, each enterprise can maintain their own customized steps to address the configurations required for third-party, or custom-developed applications.

By way of non-limiting example, a first enterprise can consume a vendor-provided system, and can include a first approach for integration and configuration. The first approach can include vendor-provided documentation for the vendor-provided system, maintaining a website for the particular project (e.g., Project Wiki), and review notifications. On the other hand, a second enterprise can consume the same vendor-provided system, and can include a second approach for integration and configuration. The second approach can include the vendor-provided documentation for the vendor-provided system, maintaining a workbook for the particular project (e.g., MS Excel workbook), and use approval emails.

Accordingly, the vendor-provided documentation addresses procedures, and technical tasks (e.g., with various recommendations) for direct integration scenarios (e.g., integration scenarios that do not consider integration scenarios including third-party, and/or custom-developed applications). As noted by way of the first enterprise and second enterprise example above, enterprises have their own customer process to be followed in order to address audit and compliance purpose apart from technical procedures. Typically, these internal processes are documented and maintained by the respective enterprises.

In view of this, and in accordance with implementations of the present disclosure, the integration service (e.g., CIAS), vendor-provided documentation is converted into a workflow format based on the integration scenario, involved systems and selected scope for the end users. In some examples, one or more pages and instructions from a vendor-provided document is converted into a set of tasks on a specific target system (e.g., a component within the landscape). One or more users receive a task containing the instructions to be followed on one or more endpoints of the vendor-provided system. In some implementations, the enterprises (customers) migrate their internal documentation and processes to adapt to the integration service. In general, the integration service has dynamic behavior with respect to simplification, automation and optimization. Consequently, the integration service is a more suitable solution for enterprises (customers), and partners (third-party application developers) to address this changing environment.

In some implementations, and from the overview of integration project setup and execution, the custom extensions take place in an enterprise-oriented phase. Consequently, and as described in further detail herein, enterprises are provided with a way to tailor the generated integration setup workflows with enterprise-specific procedures along with the vendor's standard recommendation steps. Further, the custom extension approach of the present disclosure also handles custom extension types. Example custom extension types include, without limitation, additional manual instructions, approvals/notifications emails, and setup of custom applications.

With regard to additional manual instructions, a custom extension can provide additional instructions that are to be performed by the user after a task is performed. This can be a simple HTML page containing the instructions with customer internal project tool links (e.g., open a specific JIRA page, Wiki editing). With regard to approvals/notifications emails, a custom extension can indicate that getting an approval email for a task is to be performed, and documenting the approval is part of the complete integration execution. With regard to setup of custom applications, a custom extension can provide that additional applications apart from intended targets are to be checked in detail from the integration workflow to address the customizations in the landscape (e.g., vendor-provided system provides data to an enterprise-developed (custom) application).

In accordance with implementations of the present disclosure, the integration service (e.g., CIAS) provides a unique, simple, and easy way through which a generated integration setup workflow can be customized according to the needs of respective enterprises (customers). Enterprises cannot alter the vendor-defined, standard workflow tasks. Instead, the integration service of the present disclosure enables enterprises to add additional tasks in between the workflow tasks as extensions. The enterprise-specific activities can be pushed inside the standard workflow sequence by the administrator, who initiates the workflow from a monitoring application.

In traditional approaches, in order to develop a workflow artifact, a user must have a knowledge about workflow notations, symbols, workflow editor knowledge, integrated development environment (IDE), script experience, and a runtime container. In the integration service extension approach of the present disclosure, knowledge about workflow, IDE, and tools are not required. Instead, and as described in further detail herein, a generic monitoring tool is provided, and can be used to add custom extensions in a relatively simple user experience. That is, the custom extensions are dynamically provided during a running, active instance of an integration scenario.

In some implementations, the integration service provides a messaging application (e.g., the My Inbox application of the ESP 132 of FIG. 1) to interact with individual workflow tasks. In some implementations, and as described in further detail herein, a monitoring application is provided to monitor the execution of complete workflows, as well as terminate the workflow execution. For custom extensions, the monitoring application includes functionality to enable the administrator to add custom extension tasks. In some examples, to extend a workflow, an administrator performs the following example activities in the monitoring application from a workflow instance with status running: identify the workflow execution and pause; select a task after which a custom extension is to be inserted; add task details (or fetch from templates); apply the changes; and resume execution of the workflow.

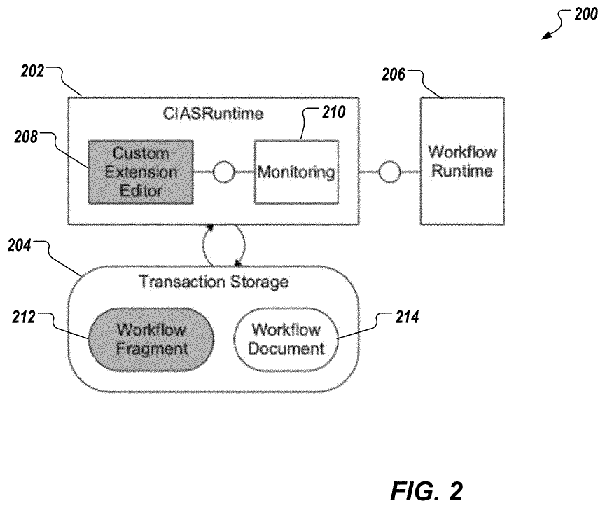

FIG. 2 depicts an example custom extension architecture 200 in accordance with implementations of the present disclosure. The example custom extension architecture 200 includes an integration services runtime 202, a transaction storage 204, and a workflow runtime 206. The integration services runtime 202 includes a custom extension editor 208, and a monitoring application 210. The transaction storage 204 includes a workflow fragment store 212, and a workflow document store 214.

In some implementations, the custom extension editor 208 is provided as a user interface (UI) application which is linked inside the monitoring application 210. In some examples, the custom extension editor 208 can be used to generate workflow fragments that are stored in the workflow fragment store 212. In some examples, and as described herein, each workflow fragment is referenced within a workflow document using a workflow task of type custom extension task. In some examples, when the integration service runtime processes the task of type custom extension, the respective workflow fragment will be executed by the workflow engine.

In some examples, the workflow document store 214 stores a plurality of workflow documents. In some examples, each workflow document is an independent lifecycle-based, standalone artifact with a unique document identifier. The workflow document contains a sequence of tasks, services calls, condition gateways, a start event, stop event, and a terminate event of a respective workflow. The workflow documents can be deployed to, and activated in the workflow engine. In some examples, only active workflow documents can be started as a workflow instance (referred with unique ID) in runtime container.

In some examples, a workflow document references one or more workflow fragments. In some examples, a workflow fragment defines a sequence of tasks and conditions without any events. In some examples, each workflow fragment includes at least one task. Workflow fragments cannot be started as an instance in the runtime container. Instead, workflow fragments are dynamic references made from a workflow running instance that is executing based on a workflow document. The container resolves the runtime reference, and interprets the task(s) included in the workflow fragment.

By default, a workflow supports user tasks, service tasks, and script tasks (e.g., tasks executed by users, services, and scripts, respectively). For the custom extension scenario, workflows are extended to support custom extension tasks. In some examples, a custom extension task has one or more attributes. example attributes include, without limitation, enable, and fragment identifier. In some examples, the enable attribute is FALSE by default. If the enable attribute is TRUE, the workflow fragment having an identifier indicated in the fragment identifier is called to avoid runtime errors.

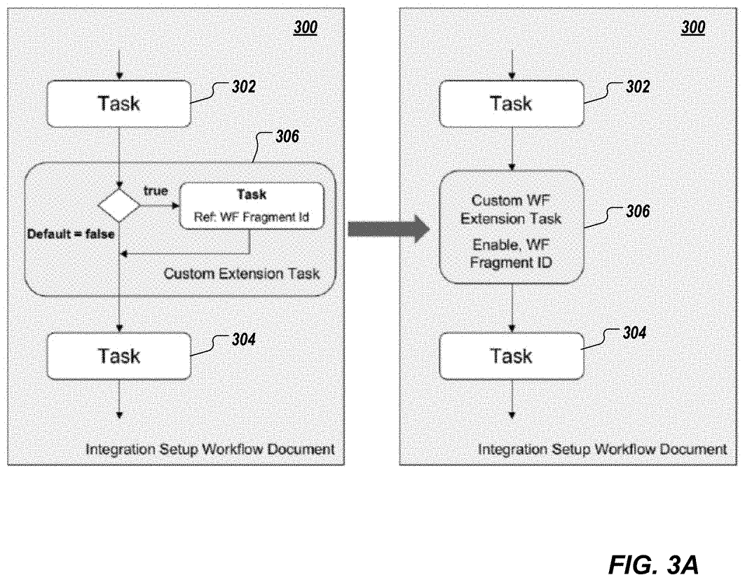

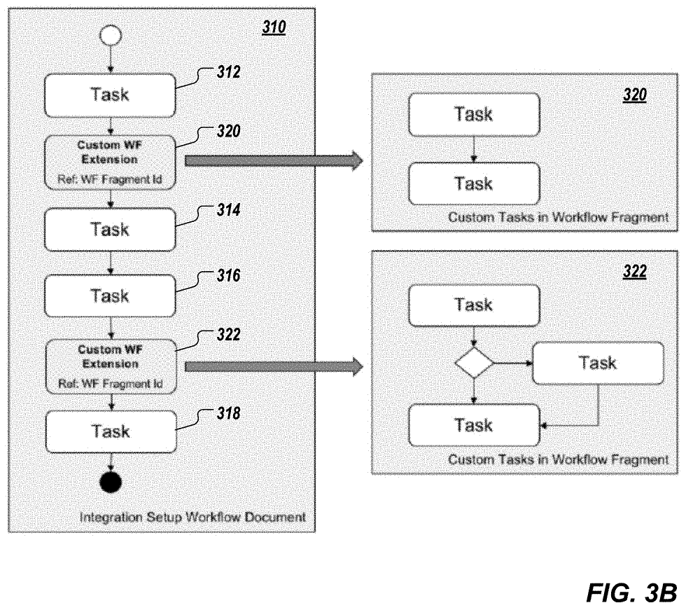

FIG. 3A depicts an example portion of a workflow 300 with a custom extension task. In the depicted example, the workflow 300 includes tasks 302, 304. In some examples, the tasks 302, 304 correspond to standard integration tasks addressed in the vendor-provided documentation. A custom extension task 306 is provided between the tasks 302, 304. In FIG. 3A, the image on the right depicts an encapsulated version of the custom extension task 306. In some implementations, after the task 302 is performed, the custom extension task is referenced by the workflow runtime (e.g., the workflow runtime 206 of FIG. 2) based on its respective fragment identifier (e.g., WF Fragment ID), and it can be determined that the enable attribute is set to TRUE. Consequently, the custom extension task defined within the workflow (WF) fragment is executed, and the workflow proceeds to the task 304. If, however, it was determined that the enable attribute is set to FALSE, the custom extension tasks is not executed, and the workflow continues to the task 304.

FIG. 3B depicts an example an example portion of a workflow 310 with custom extension tasks. In the depicted example, the workflow 310 includes tasks 312, 314, 316, 318. In some examples, the tasks 312, 314, 316, 318 correspond to standard integration tasks addressed in the vendor-provided documentation. A custom extension task 320 is provided between the tasks 312, 314, and a custom extension task 322 is provided between the tasks 316, 318. In FIG. 3B, the images on the right depict detailed views of the custom extension tasks 320, 322. In some implementations, after the task 312 is performed, the custom extension task 320 is referenced by the workflow runtime (e.g., the workflow runtime 206 of FIG. 2) based on its respective fragment identifier (e.g., WF Fragment ID), and is executed. In some implementations, after the task 316 is performed, the custom extension task 322 is referenced by the workflow runtime (e.g., the workflow runtime 206 of FIG. 2) based on its respective fragment identifier (e.g., WF Fragment ID), and is executed.

In accordance with implementations of the present disclosure, the integration setup workflow will be generated, deployed and started in a runtime container (e.g., the workflow runtime 206 of FIG. 2). In some examples, this is done automatically at the end of a planning activity within the integration service for a specific enterprise account. The generated workflow includes all possible custom extension tasks across various points, where an enterprise is able to extend the workflow. The custom extension tasks will have their enable attributes initially set to FALSE with empty fragment identifiers. In other words, an initial workflow is provided based on tasks addressed in the vendor-provided documentation with empty custom extension tasks inserted at each location within the initial workflow, where the initial workflow can include a custom extension.

In some implementations, the initial workflow is processed (e.g., by the workflow execution engine), and is monitored by a monitoring application (e.g., the monitoring application 210 of FIG. 2). When an extension point is encountered (e.g., an empty extension task) the monitoring application notifies the user. For example, a UI can be displayed to a user of the enterprise to request whether the empty custom extension task should be enabled (e.g., the enterprise has a custom extension for this point in the workflow). In some examples, the user can ignore the custom extension task (e.g., leave the enable attribute set to FALSE).

If, however, the enterprise has a custom extension for this location in the workflow, the user can set the enable attribute to TRUE, and can add a custom task (e.g., from a template, create a new task). A custom task, or sequence of custom tasks are added into a workflow fragment, and a unique identifier of the workflow fragment (WF Fragment Id) is assigned to the custom extension task. The workflow fragment is stored against customer storage. The workflow fragment can be stored as template for the customer. A workflow document can refer to multiple workflow fragments across the document in different tasks. In some examples, a workflow fragment can contain only custom tasks, email notifications, and manual instructions, but cannot refer to another workflow fragment. In some examples, the workflow fragment is defined based on user input to one or more drop-down menus displayed in the UI.

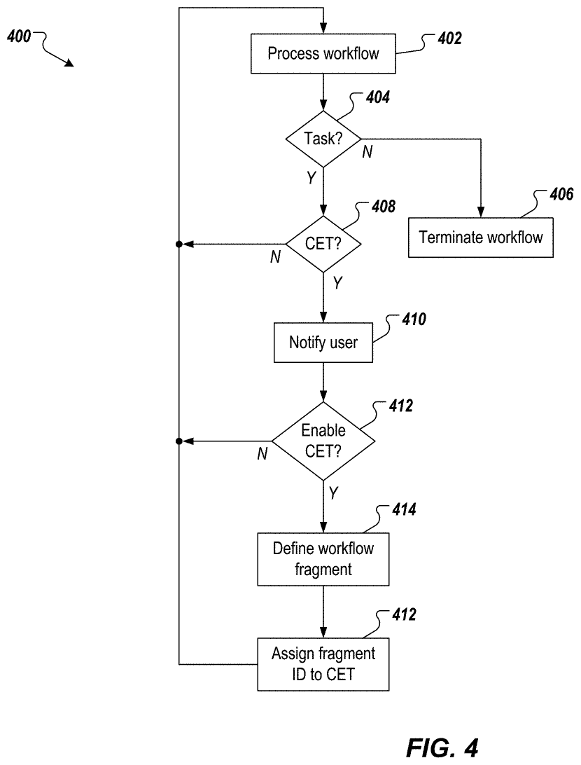

FIG. 4 depicts an example process 400 that can be executed in accordance with implementations of the present disclosure. In some examples, the example process 400 is provided using one or more computer-executable programs executed by one or more computing devices.

A workflow is processed (402). For example, the workflow runtime 206 of FIG. 2 processes tasks of the workflow. In some examples, the workflow includes tasks corresponding to tasks defined within vendor-provided documentation for an integration scenario, and at least one empty custom extension task. After a task is accounted for, it is determined whether a there is a next task in the workflow (404). If there is no next task, the workflow is terminated (406). For example, after all tasks of the workflow have been completed, there are no further tasks to account for. Consequently, the workflow can be terminated. If there is a next task, it is determined whether the next task is a custom extension task (CET) (408). If the next task is not a custom extension task, the example process 400 loops back to continue processing of the workflow. If the next task is a custom extension task, a user is notified. For example, the monitoring application 210 notifies a user of an enterprise that there is a custom extension task available to be customized.

It is determined whether the custom extension task is to be enabled (412). For example, the user can provide input to a UI of the monitoring application indicating that the custom extension task is, or is not to be enabled. If the custom extension task is not to be enabled, the example process 400 loops back to continue processing of the workflow. If the custom extension task is to be enabled, a workflow fragment is defined (414). For example, the user provides input to the UI to define one or more tasks of the custom task that are to be performed, and the workflow fragment is assigned a unique identifier (WF Fragment Id). The workflow is modified to set an enable attribute of the custom extension task within the workflow to TRUE, and to assign the workflow fragment identifier to the custom extension task (412). In this manner, when the custom extension task is encountered in execution of the workflow, the workflow fragment will be called. The example process 400 loops back to continue processing of the workflow.

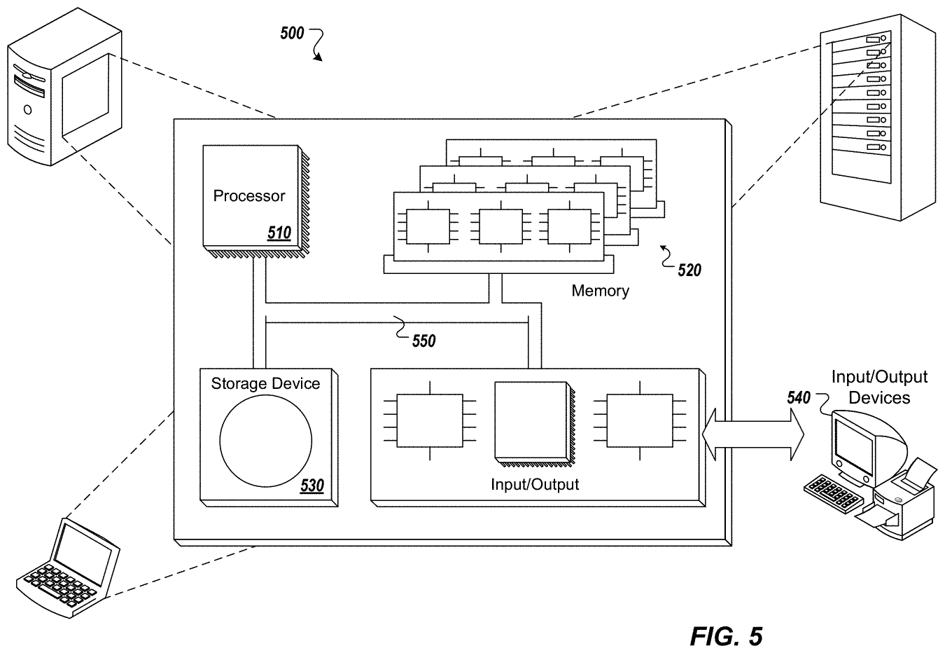

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for customizing workflows in enterprise-specific integration scenarios for enterprise-side landscapes, the method being executed by one or more processors and comprising:
executing, within a vendor-provided integration service, a workflow, the workflow comprising one or more integration tasks, and at least one empty custom extension task;
notifying, by the vendor-provided integration service, a user of an enterprise that maintains a enterprise-side landscape of the at least one empty custom extension task;
receiving, from the user, input defining a workflow fragment, the workflow fragment comprising one or more tasks, and being assigned a fragment identifier;
setting an enable attribute of the at least one empty custom extension task to true, and associating the at least one empty custom extension task with the fragment identifier to provide a non-empty custom extension task within the workflow; and
executing the workflow, during which the one or more tasks of the workflow fragment are performed.

2. The method of claim 1, wherein the one or more integration tasks comprise respective tasks defined within vendor-provided documentation for an integration scenario.

3. The method of claim 1, wherein a monitoring application monitors execution of the workflow, and notifies the user in response to occurrence of the at least one empty custom extension task.

4. The method of claim 1, wherein the one or more tasks of the workflow fragment are specific to the enterprise, and are associated with one or more of a custom-application that is to be included in the integration scenario, and a third-party application that is to be included in the integration scenario.

5. The method of claim 1, wherein the use provides the input through a user interface that enables definition of workflow fragments.

6. The method of claim 5, wherein the user interface is provided by a custom extension editor application of the integration service.

7. The method of claim 1, wherein the workflow comprises a plurality of empty custom extension tasks, each empty custom extension task being at a location that is available for extension of the workflow.

8. A non-transitory computer-readable storage medium coupled to one or more processors and having instructions stored thereon which, when executed by the one or more processors, cause the one or more processors to perform operations for customizing workflows in enterprise-specific integration scenarios for enterprise-side landscapes, the operations comprising:
executing, within a vendor-provided integration service, a workflow, the workflow comprising one or more integration tasks, and at least one empty custom extension task;
notifying, by the vendor-provided integration service, a user of an enterprise that maintains a enterprise-side landscape of the at least one empty custom extension task;
receiving, from the user, input defining a workflow fragment, the workflow fragment comprising one or more tasks, and being assigned a fragment identifier;
setting an enable attribute of the at least one empty custom extension task to true, and associating the at least one empty custom extension task with the fragment identifier to provide a non-empty custom extension task within the workflow; and
executing the workflow, during which the one or more tasks of the workflow fragment are performed.

9. The computer-readable storage medium of claim 8, wherein the one or more integration tasks comprise respective tasks defined within vendor-provided documentation for an integration scenario.

10. The computer-readable storage medium of claim 8, wherein a monitoring application monitors execution of the workflow, and notifies the user in response to occurrence of the at least one empty custom extension task.

11. The computer-readable storage medium of claim 8, wherein the one or more tasks of the workflow fragment are specific to the enterprise, and are associated with one or more of a custom-application that is to be included in the integration scenario, and a third-party application that is to be included in the integration scenario.

12. The computer-readable storage medium of claim 8, wherein the use provides the input through a user interface that enables definition of workflow fragments.

13. The computer-readable storage medium of claim 12, wherein the user interface is provided by a custom extension editor application of the integration service.

14. The computer-readable storage medium of claim 8, wherein the workflow comprises a plurality of empty custom extension tasks, each empty custom extension task being at a location that is available for extension of the workflow.

15. A system, comprising:
a computing device; and
a computer-readable storage device coupled to the computing device and having instructions stored thereon which, when executed by the computing device, cause the computing device to perform operations for customizing workflows in enterprise-specific integration scenarios for enterprise-side landscapes, the operations comprising:
executing, within a vendor-provided integration service, a workflow, the workflow comprising one or more integration tasks, and at least one empty custom extension task;
notifying, by the vendor-provided integration service, a user of an enterprise that maintains a enterprise-side landscape of the at least one empty custom extension task;
receiving, from the user, input defining a workflow fragment, the workflow fragment comprising one or more tasks, and being assigned a fragment identifier;
setting an enable attribute of the at least one empty custom extension task to true, and associating the at least one empty custom extension task with the fragment identifier to provide a non-empty custom extension task within the workflow; and
executing the workflow, during which the one or more tasks of the workflow fragment are performed.

16. The system of claim 15, wherein the one or more integration tasks comprise respective tasks defined within vendor-provided documentation for an integration scenario.

17. The system of claim 15, wherein a monitoring application monitors execution of the workflow, and notifies the user in response to occurrence of the at least one empty custom extension task.

18. The system of claim 15, wherein the one or more tasks of the workflow fragment are specific to the enterprise, and are associated with one or more of a custom-application that is to be included in the integration scenario, and a third-party application that is to be included in the integration scenario.

19. The system of claim 15, wherein the use provides the input through a user interface that enables definition of workflow fragments.

20. The system of claim 19, wherein the user interface is provided by a custom extension editor application of the integration service.
